(19) United States
(12) Patent Application Publication
(10) Pub. No.: US 2026/0300440 A1
(43) Pub. Date: Oct. 1, 2026

(54) SYSTEMS, METHODS, APPARATUSES, AND COMPUTER PROGRAMS FOR ALERT CORRELATION BASED ON TIERED TECHNIQUES FOR ENABLING VARIABLE DOWNSTREAM LATENCY RESOLUTION

(71) Applicant: ATLASSIAN PTY, LTD., Sydney (AU)

(72) Inventors: Anuj NIGAM, Pune (IN); Prateek MANDLOI, Bangalore (IN); Atri MANDAL, Bangalore (IN); Mayank SAWHNEY, Bengaluru (IN); Bhuvanesh Nathmal JAIN, Bangalore (IN)

(21) Appl. No.: 19/249,557

(22) Filed: Jun. 25, 2025

Related U.S. Application Data
(63) Continuation of application No. 19/095,503, filed on Mar. 31, 2025.

(51) Int. Cl. G06F 18/2321

(52) U.S. Cl. CPC G06F 18/2321

(57) ABSTRACT

Various embodiments disclosed herein are directed to a system, method, apparatus, and/or a computer program product that are configured to receive, from a causal inference module, a first and a second cluster-based timeseries, wherein each cluster-based timeseries is comprised of a plurality of correlated alert data objects, determine a downstream latency, wherein the downstream latency indicates a time delay between a start time of an anomalous subgroup of the first cluster-based timeseries and a start time of a correlated anomalous subgroup of the second cluster-based timeseries, generate, based on the downstream latency, the first and the second cluster-based timeseries, a first second refined cluster-based timeseries, wherein each cluster-based timeseries is refined by partitioning each cluster-based timeseries into subgroups based on the downstream latency, and determine an updated downstream latency by iteratively refining the first and the second refined cluster-based timeseries until a timeseries correlation score reaches a predefined threshold.

### CROSS-REFERENCES TO RELATED APPLICATIONS

The present application is a continuation of U.S. patent application Ser. No. 19/095,503 filed Mar. 31, 2025, which is incorporated herein by reference in its entirety.

### TECHNICAL FIELD

The present disclosure relates generally to alert management. In particular, it relates to systems that are configured to process alerts in software management platforms.

### BACKGROUND

Alert management is an essential aspect of software development and IT service management in a software application. Applicant has identified a number of technical problems associated with alert management tools. Through applied effort, ingenuity, and innovation, Applicant has solved problems relating to alert management by developing solutions embodied in the present disclosure, which are described in detail below.

### SUMMARY

In one embodiment, an apparatus comprising one or more processors and one or more memories storing instructions that are operable, when executed by the one or more processors, to cause the apparatus to receive, from a causal inference module, a first cluster-based timeseries and a second cluster-based timeseries, wherein each cluster-based timeseries is comprised of a plurality of similar and/or correlated alert data objects, determine a downstream latency, wherein the downstream latency indicates a time delay between a start time of an anomalous subgroup of the first cluster-based timeseries and a start time of a correlated anomalous subgroup of the second cluster-based timeseries, generate, based on the downstream latency, the first cluster-based timeseries, and the second cluster-based timeseries, a first refined cluster-based timeseries and a second refined cluster-based timeseries, wherein each cluster-based timeseries is refined by partitioning each cluster-based timeseries into subgroups based on the downstream latency, and determine an updated downstream latency by iteratively refining the first refined cluster-based timeseries and the second refined cluster-based timeseries until a timeseries correlation score reaches a predefined timeseries correlation threshold.

In another embodiment, the apparatus is further configured to iteratively refine the first refined cluster-based timeseries and the second refined cluster-based timeseries by partitioning each cluster-based timeseries into updated subgroups based on the downstream latency, identifying, based on the updated subgroups, a set of updated anomalous subgroups, modelling, based on a probability distribution, time deltas between a start time of each updated anomalous subgroup of the set of updated anomalous subgroups, determining an updated timeseries correlation score between anomalous subgroups of the first refined cluster-based timeseries and anomalous subgroups of the second refined cluster-based timeseries, and determining, based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

In another embodiment, the apparatus is further configured to identify, based on the subgroups, a set of anomalous subgroups of the first refined cluster-based timeseries and the second refined cluster-based timeseries and determine the timeseries correlation score between the set of anomalous subgroups of the first refined cluster-based timeseries and the set of anomalous subgroups of the second refined cluster-based timeseries.

In another embodiment, the downstream latency is determined based at least in part on the timeseries correlation score.

In another embodiment, the apparatus is further configured to generate, based on the updated downstream latency, the first refined cluster-based timeseries, and the second refined cluster-based timeseries, a first updated cluster-based timeseries and a second updated cluster-based timeseries and transmit, to an alert management system, the first updated cluster-based timeseries and a second updated cluster-based timeseries.

In another embodiment, generating the first updated cluster-based timeseries and the second updated cluster-based timeseries further comprises partitioning each cluster-based timeseries into subgroups based on the updated downstream latency.

In another embodiment, the first updated cluster-based timeseries and the second updated cluster-based timeseries are configured to enable the alert management system to efficiently handle alerts.

In yet another embodiment, a computer-implemented method is provided. The method comprises receiving, from a causal inference module, a first cluster-based timeseries and a second cluster-based timeseries, wherein each cluster-based timeseries is comprised of a plurality of similar and/or correlated alert data objects, determining a downstream latency, wherein the downstream latency indicates a time delay between a start time of an anomalous subgroup of the first cluster-based timeseries and a start time of a correlated anomalous subgroup of the second cluster-based timeseries, generating, based on the downstream latency, the first cluster-based timeseries, and the second cluster-based timeseries, a first refined cluster-based timeseries and a second refined cluster-based timeseries, wherein each cluster-based timeseries is refined by partitioning each cluster-based timeseries into subgroups based on the downstream latency, and determining an updated downstream latency via a multi-tiered timeseries refinement process until a timeseries correlation score reaches a predefined timeseries correlation threshold.

In another embodiment, the multi-tiered timeseries refinement process further comprises iteratively refining the first refined cluster-based timeseries and the second refined cluster-based timeseries by partitioning, by a timeseries refinement module, each cluster-based timeseries into updated subgroups based on the downstream latency, identifying, by a timeseries correlation module and based on the updated subgroups, a set of updated anomalous subgroups, modelling, by the timeseries correlation module and based on a probability distribution, time deltas between a start time of each updated anomalous subgroup of the set of updated anomalous subgroups, determining, by the timeseries correlation module, an updated timeseries correlation score between anomalous subgroups of the first refined cluster-based timeseries and anomalous subgroups of the second refined cluster-based timeseries, and determining, by a variable downstream latency resolution model and based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

In another embodiment, the method further comprises identifying, based on the subgroups, a set of anomalous subgroups of the first refined cluster-based timeseries and the second refined cluster-based timeseries and determining the timeseries correlation score between the set of anomalous subgroups of the first refined cluster-based timeseries and the set of anomalous subgroups of the second refined cluster-based timeseries.

In another embodiment, the method further comprises generating, based on the updated downstream latency, the first refined cluster-based timeseries, and the second refined cluster-based timeseries, a first updated cluster-based timeseries and a second updated cluster-based timeseries and transmitting, to an alert management system, the first updated cluster-based timeseries and a second updated cluster-based timeseries.

In yet another embodiment, a computer program product is provided comprising at least one non-transitory computer-readable storage medium having computer-readable program code portions stored therein, the computer-readable program code portions comprising an executable portion configured to receive, from a causal inference module, a first cluster-based timeseries and a second cluster-based timeseries, wherein each cluster-based timeseries is comprised of a plurality of similar and/or correlated alert data objects, determine a downstream latency, wherein the downstream latency indicates a time delay between a start time of an anomalous subgroup of the first cluster-based timeseries and a start time of a correlated anomalous subgroup of the second cluster-based timeseries, generate, based on the downstream latency, the first cluster-based timeseries, and the second cluster-based timeseries, a first refined cluster-based timeseries and a second refined cluster-based timeseries, wherein each cluster-based timeseries is refined by partitioning each cluster-based timeseries into subgroups based on the downstream latency, and determine an updated downstream latency by iteratively refining the first refined cluster-based timeseries and the second refined cluster-based timeseries until a timeseries correlation score reaches a predefined timeseries correlation threshold.

In another embodiment, the computer program product is further configured to iteratively refine the first refined cluster-based timeseries and the second refined cluster-based timeseries by partitioning each cluster-based timeseries into updated subgroups based on the downstream latency, identifying, based on the updated subgroups, a set of updated anomalous subgroups, modelling, based on a probability distribution, time deltas between a start time of each updated anomalous subgroup of the set of updated anomalous subgroups, determining an updated timeseries correlation score between anomalous subgroups of the first refined cluster-based timeseries and anomalous subgroups of the second refined cluster-based timeseries, determining, based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

In another embodiment, the computer program product is further configured to identify, based on the subgroups, a set of anomalous subgroups of the first refined cluster-based timeseries and the second refined cluster-based timeseries and determine the timeseries correlation score between the set of anomalous subgroups of the first refined cluster-based timeseries and the set of anomalous subgroups of the second refined cluster-based timeseries.

In another embodiment, the computer program product is further configured to generate, based on the updated downstream latency, the first refined cluster-based timeseries, and the second refined cluster-based timeseries, a first updated cluster-based timeseries and a second updated cluster-based timeseries and transmit, to an alert management system, the first updated cluster-based timeseries and a second updated cluster-based timeseries.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1A illustrates a schematic view of an example system architecture for an alert correlation and inference system configured to monitor a multi-layer service-oriented platform in accordance with one or more embodiments of the present disclosure;

FIG. 1B illustrates a detail schematic view of an example system architecture for an alert correlation and inference system comprising a causal inference system and a variable downstream latency resolution system configured to interface with an alert management system in accordance with one or more embodiments of the present disclosure;

FIG. 2 illustrates a schematic view of an example apparatus configured to embody a causal inference apparatus and a variable downstream latency resolution apparatus in accordance with one or more embodiments of the present disclosure;

FIG. 3 illustrates a schematic view of an example data flow for generating a cluster-based timeseries by a causal inference system in accordance with one or more embodiments of the present disclosure;

FIG. 4 illustrates schematic view of an example data flow for generating an updated cluster-based timeseries by a variable downstream latency resolution system in accordance with one or more embodiments of the present disclosure;

FIG. 5 shows a flow chart illustrating an example method of generating a cluster-based timeseries and determining an updated causal dependence score map in accordance with one or more embodiments of the present disclosure;

FIG. 6 shows a flow chart illustrating an example method of determining an updated downstream latency for a first and second refined cluster-based timeseries in accordance with one or more embodiments of the present disclosure; and

FIG. 7 shows a flow chart illustrating an example method of iteratively refining a first and second refined cluster-based timeseries in accordance with one or more embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Overview

Some embodiments of the present disclosure address technical problems associated with alert correlation in a large multi-layer service-oriented platform involving interdependent services and microservices that support a myriad of software features, applications, and software development functions. Indeed, some large multi-layer service-oriented platforms may be comprised of topologies of 1,500 or more interdependent services and microservices. Such multi-layer service-oriented platforms are nimble, highly configurable, and enable robust collaboration and communication between users at the individual, team, and enterprise level.

Computing devices operating on, or otherwise supporting, such multi-layer service-oriented platforms routinely generate, transmit, and store millions of data objects. As they do so, some data objects or associated operations may trigger alerts and/or more serious incidents that are tracked and monitored by information technology service management (ITSM) software applications such as Jira Service Management (JSM) or OpsGenie by Atlassian, Inc., which are example alert management systems as discussed herein.

Given the complexity of large multi-layer service-oriented platforms, it can be difficult to understand potential causes and possible solutions of software incidents. This difficulty is exacerbated when one considers that code deployments among the multitude of interdependent services and microservices are in constant flux as updates occur and new or improved features are released.

Alert management is an essential aspect of running a successful software application especially when deployed within a large multi-layer service-oriented platform. Alert management systems are configured to provide and facilitate alert management in software applications. However, many alert management systems are perhaps too good at their primary job of generating alerts in association with events of the complex service topology of the software application. Such alert management systems generate huge volumes of alerts that must be reviewed, handled, and disposed of by alert managers. Alert overload may be particularly acute in multi-layer service-orientated platforms as alerts might be triggered by dozens or hundreds of services or microservices. Alert overload may produce alert fatigue that may in turn lead to errors, misdiagnoses of underlying software errors, and potential service outages.

The complex and ever-changing service and microservice topologies of multi-layer service-oriented platforms magnify the problem of alert volume. Errors that trigger alerts in one service can cause cascading waves of alerts in downstream services that depend upon the service in which the original error occurred, creating a snowball effect of alert generation that, in many cases, obfuscates the original error and overwhelms any monitoring alert manager. Detecting correlation and causal dependence between alerts is important for enabling alert management systems to reduce alert noise and more efficiently perform fault localization, blast radius estimation, root cause analysis, and incident prediction.

As noted above, alerts triggered in a multi-layer service-oriented platforms may cause cascading waves of alerts that are triggered in succession by inter-related services and microservices. Various embodiments discussed herein are configured to accurately correlate alerts originating from the related services and microservices to support error or fault localization and triage. Various embodiments further support blast radius estimation processes that enable an alert management system to determine which services are affected by a specific problem and to thereby gauge the potential impact on other services. Estimating the blast radius also enables alert management systems discussed herein to determine the severity of an incident or potential incident.

Various embodiments discussed herein are further configured to perform root cause analysis by deploying a combination of fault localization, blast radius estimation, and analyses of additional data such as logs, traces, commits, metrics, etc. By programmatically inferring causal dependence and correlation of alerts in complex multi-layer service-oriented platforms, various alert management system embodiments discussed herein are configured to better predict and mitigate future errors or incidents.

According to various embodiments, there is provided a system, method, apparatus, and/or a computer program that is configured to generate cluster-based timeseries of alert data objects by extracting alert feature dimensions from alert data objects, applying a semantic similarity model and other similarity methods to generate a causal dependence score map. By generating the causal dependence score map, various embodiments quantify a degree to which a given alert data object is similar to other alert data objects. Based at least in part on the causal dependence score map, cluster-based timeseries are generated by applying a clustering model to a selected alert data objects set and partitioning the clusters into subgroups based on the timestamp of occurrence of the alert data objects.

In various embodiments, a first cluster-based timeseries is comprised of alert data objects originating from a first service and a second cluster-based timeseries is comprised of alert data objects originating from a second service. These cluster-based timeseries are configured to enable an alert management system to perform analysis to determine causal relationships between alerts originating from related services.

According to various embodiments, there is further provided a system, method, apparatus, and/or a computer program that is configured to iteratively refine a first and second cluster-based timeseries by adjusting a configurable time threshold such as downstream latency to partition the subgroups of the cluster-based timeseries. Various embodiments utilize a timeseries correlation score to quantify a degree to which anomalous subgroups of one cluster-based timeseries are correlated to anomalous subgroups of another cluster-based timeseries. By iteratively updating the downstream latency, the timeseries correlation score is gradually improved, thus generating a refined cluster-based timeseries, enabling an alert management system to perform root cause analysis and incident prediction with greatly improved accuracy.

### Definitions

The term “multi-layer service-oriented platform” refers to a complex network computing environment associated with a multitude of computing devices, applications, services, and microservices. For example, in some embodiments, a multi-later service-oriented platform includes dozens of applications that are supported by 1000+ services or microservices operating in complex mesh or graph-like topologies within a cloud-based platform. Example multi-layer service-oriented platforms may comprise a federated network of computing devices, and/or a plurality of database platforms (e.g., servers, hard-drives, etc.).

The term “alert management system” refers to a software application that is configured to monitor another software application operating within a multi-layer service-oriented platform. Alert management systems are deployed via a combination of computer hardware and/or software that is configured to monitor one or more software applications and its associated alerts. Alert management systems according to various embodiments are configured to be deployed in coordination with a causal interference system and/or a variable downstream latency resolution system to correlate alerts and mitigate excessive alert volumes thereby improving operation of monitored software applications and reducing alert overload among alert managers.

Such alert management systems monitor a software application such that the one or more services, applications, features, tools, and/or products associated with the software application are not adversely impacted (e.g., are not impacted by bandwidth and/or resource limitations caused by high alert traffic and/or excessive alert escalation). An example alert monitoring management system is Opsgenie® or Jira Service Management (JSM)® by Atlassian®.

Alert management systems are configured to generate and/or receive large volumes of alerts (e.g., an alert data objects set) related to one or more respective cautions, problems, errors, issues, flags, vulnerabilities, and/or incidents associated with the software application. Alerts may be triggered at the service level, the feature level, the application level, and the like. Alerts may be scored, ranked, or categorized by type, impact, severity, frequency, or other characteristics.

The term “service” refers to a computer program or a group of computer programs designed to provide a software functionality or a set of software functionalities via a multi-layer service-oriented platform. For example, a service may be configured to retrieve specified information or to execute a set of operations aimed at a particular purpose. Applications and/or client devices may be configured to use such services to execute their respective purposes, together with the policies that control service usage, for example, based on the identity of the client (e.g., an application, another service, etc.) requesting the service. Additionally, a service may support, or be supported by, at least one other service via a service dependency relationship. For example, a translation application stored on a smartphone may call a translation dictionary service at a server in order to translate a particular word or phrase between two languages. In such an example, the translation application is dependent on the translation dictionary service to perform the translation task.

In some embodiments, a service is offered by one computing device over a network to one or more other computing devices. Services may be supported by internal resources or external resources as defined below. In some embodiments, services may be accessed by other services via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, services may be configured to capture or utilize database information and asynchronous communications via message queues (e.g., Event Bus). Non-limiting examples of services include an open source API definition format, an API logger, a network diagnostics tool, a geofencing service, a single sign-on enforcement service, an internal developer tool, web based HTTP services, databased services, asynchronous message queues which facilitate service-to-service communications, or the like.

In some embodiments, a service can represent an operation with a specified outcome and can further be a self-contained software program. In some embodiments, a service from the perspective of the client (e.g., another service, application, etc.) can be a black box meaning that the client need not be aware of the service's inner workings. In some embodiments, a first service may transmit an alert to one or more second services, and/or applications, via an API supported by communication circuitry.

The term “service topology” refers to a mapping of dependency relationships between services of a software application such as a multi-layered service-oriented platform. Illustrations of nodes of a service topology are connected by arrows or edges indicating the direction of dependency between multiple services. Any service can be dependent on one or more services and can be depended on by one or more services. A service which is depended on by another service is called an upstream service. A service which is dependent on another service is called a downstream service. A collection of service nodes and edges can be referred to as a service graph.

The term “events” refers to one or more computer-based activities that occur in a software application (or one or more services of the software application) that trigger one or more alerts within an alert management system. Events occurring in services of a software application, such as a multi-layered service-oriented platform being monitored by an alert management system, are detected by or transmitted to the alert management system, thus triggering generation of one or more alerts. Events are associated with any action or activity taking place within a software application. It is the responsibility of the alert management system to determine if a given event requires generation of an alert based on rules, policies, configurations, or logic of the alert management system.

The term “alerts” refers to one or more cautions, problems, errors, issues, flags, and/or incidents that are generated by an alert management system that is configured to monitor a software application. Alerts are embodied as any data construct and/or data object generated by an alert management system or user indicating the status and/or operating functionality of a component, module, service, microservice, feature, application, and/or device within a software application. Such operating functionality may include indicators regarding the performance of a component (e.g., whether the component and its functions are running at peak speed or slower than peak speed, if certain functions or capabilities are not running at peak performance or not running at all, etc.). Further, operating functionality may include security threats (e.g., unauthorized access, data breaches, etc.), compliance issues (e.g., violation of data privacy), system failures (e.g., application crash, server down, network connection lost, etc.).

The term “metric” refers to parameters, characteristics, data, analytics, or the like that are generated by a software application and usable by an alert management system to monitor or measure the performance, productivity, or functionality of the software application, a software application feature, or any constituent service. Metrics like service latency, error rate, traffic volume, and saturation can be analyzed in conjunction with alerts and logs to improve alert correlation accuracy. “Golden signal” metrics are metrics that serve as key indicators of errors or other alert generating events in a software application.

The term “log” refers to a continuous stream of data files generated by a software application or constituent service that provide a historical record of system activities or events. Logs may provide insights into the internal states and control flow of individual components, services, and/or microservices of a software application or a software application feature. Logs can be analyzed in conjunction with alerts and metrics to improve alert correlation accuracy.

The term “alert data object” refers to a data entity representative of an alert, metric, and/or log associated with a software application or component thereof. An alert data object is comprised of timestamp data and textual data describing an event associated with a software system being monitored by an alert management system. Alert data objects may be generated by an alert management system as physical embodiments of alerts, metrics, and/or logs for storage and transmission to related systems, such as a causal inference system and/or a variable downstream latency resolution system as described herein. Alert data objects are further configured to include alert attributes that are extracted as alert feature dimensions as defined herein.

Alert data objects include textual data descriptive and/or representative of an associated event, alert, or cause for which the alert data object was generated. For example, alert data objects may include textual strings, characters, numbers, or the like such as titles, names, tags, descriptions, timestamps, metadata, or the like.

In some embodiments, alert data objects that are generated based on metrics and logs are received by an alert management system but generated by a native external service or application that generated the associated metrics and logs. Thus, alert data objects need not be generated directly by the alert management system in all circumstances.

The term “alert feature dimension” refers to any data object, detail, attribute, embedding transformation, or the like that is extracted from an alert data object by an alert feature dimension extraction module. Such alert feature dimensions include embedding or vector transformations of text (e.g., alert message components, problem descriptions, etc.), software identifiers, service or microservice identifiers, team identifiers, deployment description data, log data, metric data, and other data or metadata that are configured for input into an alert similarity module such as a semantic similarity model.

The term “alert feature dimension extraction module” refers to a program, service, or microservice that is configured to extract alert feature dimensions from alert data objects. Alert feature dimension extraction module is configured to receive alert data objects (e.g. an alert data objects set) from an alert management system, extract alert feature dimensions from the alert data objects, and provide the alert feature dimensions to an alert similarity module and a causal inference module. In some embodiments, alert feature dimension extraction module is configured to receive a set of known feature dimensions from an alert management system for verifying extracted alert feature dimensions.

The term “alert similarity module” refers to any program, service, or microservice that is configured to generate similarity scores for alert data objects based on each alert data object's alert feature dimensions. Similarity scores quantify a degree to which two or more alert data objects are similar to one another based on learned or pre-defined parameters or criteria. An alert similarity module is configured to receive alert feature dimensions from an alert feature extraction module and provide similarity scores to a causal inference module. In some embodiments, an alert similarity module is configured to generate and provide an initial causal dependence score map to a causal inference module.

The term “semantic similarity model” refers to a program, service, or microservice that is configured to generate semantic similarity scores for alert data objects based on each alert data object's alert feature dimensions. Semantic similarity scores quantify a degree to which two or more alert data objects comprise similar semantic data. Processing alert feature dimensions to generate semantic similarity scores involves identifying specific details or information from alert data object data by identifying keywords and analyzing the semantics and syntax of the data. In some embodiments, the semantic similarity model is an example of an alert similarity module. In some embodiments, semantic similarity scores are examples of similarity scores. In some embodiments, a semantic similarity model is configured to generate and provide an initial causal dependence score map to a causal inference module.

The term “causal inference module” refers to a program, service, or microservice that is configured to generate cluster-based timeseries based on the timestamp of the alert data objects, and similarity scores between each alert data object. A causal inference module is configured to receive alert feature dimensions from an alert feature dimension extraction module and an initial causal dependence score map from an alert similarity module. A causal inference module is configured to apply a clustering model to a selected alert data objects subset to generate a cluster-based timeseries. A causal inference module is further configured to update the initial causal dependence score map based on the cluster-based timeseries.

The term “initial causal dependence score map” refers to a mapping of similarity scores between alert data objects in an alert data objects set. Alert data objects having similarity scores which satisfy a similarity score threshold are considered to be similar. Conversely, alert data objects having similarity scores which do not satisfy a similarity score threshold are considered to be less similar. Similarity between alert data objects indicate the possibility for a causally dependent relationship between the alert data objects and the services from which they originated. An initial causal dependence score map is generated by an alert similarity module, such as a semantic similarity model.

The term “updated causal dependence score map” refers to an updated mapping of similarity scores between alert data objects in an alert data objects set that takes in to account the results of clustering alerts into cluster-based timeseries. For example, alert data objects assigned to the same cluster and/or subgroup of a cluster-based timeseries may have their respective similarity scores updated to be greater than they were in the initial causal dependence score map. Conversely, alert data objects not assigned to the same cluster and/or subgroup of a cluster-based timeseries may have their respective similarity scores updated to be lower than they were in the initial causal dependence score map. The updated causal dependence score map provides further insight into causally dependent relationships between services of a software application being monitored by an alert management system. An updated causal dependence score map is generated by a causal inference module based on an initial causal dependence score map and one or more cluster-based timeseries.

The term “timeseries” refers to a cluster of alert data objects that have been determined to be similar by a causal inference module and have been partitioned into subgroups based on the timestamp of occurrence of each alert data object in the cluster. In some embodiments, the breadth of each subgroup is determined by a configurable time threshold. A timeseries is generated by a causal inference module and is refined and updated by a variable downstream latency resolution system.

The term “causal influence” refers to the effect that the alerts of an alert cluster in one timeseries have on the existence of alerts of another alert cluster in another timeseries. For example, if alert cluster X is said to have a causal influence on alert cluster Y, it means that the events in a software application that triggered the generation of the alerts in cluster X have a direct or indirect influence on the events in a software application that triggered the generation of the alerts in cluster Y.

The term “configurable time threshold” refers to a parameter of a timeseries configured to control the breadth of each subgroup. Each subgroup is bounded by a start time and an end time. The configurable time threshold determines the difference between the start time and the end time. The configurable time threshold is configured to be iteratively updated based on a downstream latency or an updated downstream latency.

The term “downstream latency” or “time lag” refers to the time elapsed from the generation of an alert in a first cluster-based timeseries (e.g. from alert cluster X above), to the generation of a correlated alert in a second cluster-based timeseries (e.g. from alert cluster Y above), wherein it has been determined that the alerts of cluster X in the first cluster-based timeseries have a causal influence on the alerts of cluster Y in the second cluster-based timeseries. The downstream latency can be used to measure the latency between two related programs, services, or microservices to perform root cause analysis of errors in a software application. In some embodiments, downstream latency is measured from a start time of a first subgroup to a start time of a second subgroup.

The term “refined cluster-based timeseries” refers to cluster-based timeseries that have been repartitioned into new subgroups based on an update to their configurable time threshold. In some embodiments, refined cluster-based timeseries are generated by a timeseries refinement module.

The term “timeseries refinement module” refers to a program, service, or microservice that is configured to generate refined cluster-based timeseries based on an updated downstream latency determined by a variable downstream latency resolution model. In some embodiments, upon a determination that a timeseries correlation score associated with the refined or updated cluster-based timeseries reached a predefined timeseries correlation threshold, the timeseries refinement module is configured to provide the refined or updated cluster-based timeseries to an alert management system.

The term “anomalous subgroup” refers to a subgroup of a cluster-based timeseries containing an abnormally large number of alerts, a high frequency of similar alerts, and/or occurrences of rare or severe alerts. Anomalous subgroups are identified by a timeseries correlation module. Anomalous subgroups of different cluster-based timeseries are determined to be correlated if they contain semantically similar alerts, matching or near-matching abnormally large numbers of alerts, matching or near-matching frequencies of similar alerts, or matching or near-matching occurrences of rare or severe alerts.

The term “timeseries correlation score” refers to a value generated by a timeseries correlation module that indicates a degree to which an anomalous subgroup of a first cluster-based timeseries is correlated to an anomalous subgroup of a second cluster-based timeseries. In some embodiments, the timeseries correlation score is used by a variable downstream latency resolution model as a basis for further refinement of cluster-based timeseries to update the downstream latency/configurable time threshold.

The term “timeseries correlation module” refers to a program, service, or microservice that is configured to identify anomalous subgroups of a first cluster-based timeseries and anomalous subgroups of a second cluster-based timeseries, generate a timeseries correlation score between each anomalous subgroup of the first cluster-based timeseries and each correlated anomalous subgroup of the second cluster-based timeseries, and provide data describing the identification of each anomalous subgroup and their timeseries correlation scores to a variable downstream latency resolution model.

The term “timeseries correlation data” refers to data generated by a timeseries correlation module and provided to a variable downstream latency resolution model. Timeseries correlation data comprises data identifying the anomalous subgroups of each cluster-based timeseries and timeseries correlation scores between the correlated anomalous subgroups of each cluster-based timeseries.

The term “variable downstream latency resolution model” refers to program, service, or microservice configured to optimize the downstream latency, or configurable time threshold, of two or more cluster-based timeseries to search for a best known timeseries correlation score. The downstream latency associated with the best known timeseries correlation score is the optimal or updated downstream latency. The optimal or updated downstream latency is determined based on timeseries correlation data obtained from a timeseries correlation module. In some embodiments, a variable downstream latency resolution model may transmit an updated downstream latency to a timeseries refinement module to retrigger a timeseries refinement process using the updated downstream latency.

The terms “client device”, “computing device”, “user device”, and the like may be used interchangeably to refer to computer hardware that is configured (either physically or by the execution of software) to access one or more of an application, service, or repository made available by a server (e.g., apparatus of the present disclosure) and, among various other functions, is configured to directly, or indirectly, transmit and receive data. The server is often (but not always) on another computer system, in which case the client device accesses the service by way of a network. Example client devices include, without limitation, smart phones, tablet computers, laptop computers, wearable devices (e.g., integrated within watches or smartwatches, eyewear, helmets, hats, clothing, earpieces with wireless connectivity, and the like), personal computers, desktop computers, enterprise computers, the like, and any other computing devices known to one skilled in the art in light of the present disclosure.

The terms “data,” “content,” “digital content,” “digital content object,” “signal,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media.

Examples of non-transitory computer-readable media include a magnetic computer readable medium (e.g., a floppy disk, hard disk, magnetic tape, any other magnetic medium), an optical computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use computer-readable storage medium, other types of computer-readable mediums can be substituted for or used in addition to the computer-readable storage medium in alternative embodiments.

The terms “application,” “software application,” “app,” “product,” “service” or other similar terms refer to a computer program or group of computer programs designed to perform coordinated functions, tasks, or activities for the benefit of a user or group of users. A software application can run on a server or group of servers (e.g., physical or virtual servers in a cloud-based computing environment). In certain embodiments, an application is designed for use by and interaction with one or more local, networked or remote computing devices, such as, but not limited to, client devices. Non-limiting examples of an application comprise project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “machine learning module,” “machine learning model,” “ML module(s),” or “ML model(s)” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted.

The machine learning models as described herein may make use of multiple ML engines (e.g., for analysis, transformation, and other needs). The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models may be some form of neural network. The underlying ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders).

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein. The ML models herein may undergo a second or multiple subsequent training phases for retraining the models.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present invention and may be included in more than one embodiment of the present invention (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

Having set forth a series of definitions called-upon throughout this application, an example system architecture and example apparatus is described below for implementing example embodiments and features of the present disclosure.

### Example System Architectures

Methods, apparatuses, and computer program products of the present disclosure may be embodied by any of a variety of devices. For example, the method, apparatus, and computer program product of an example embodiment may be embodied by a networked device (e.g., an enterprise platform, service-oriented platform, and/or software application, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, virtual reality device, augmented reality device, the like, or any combination of the aforementioned devices.

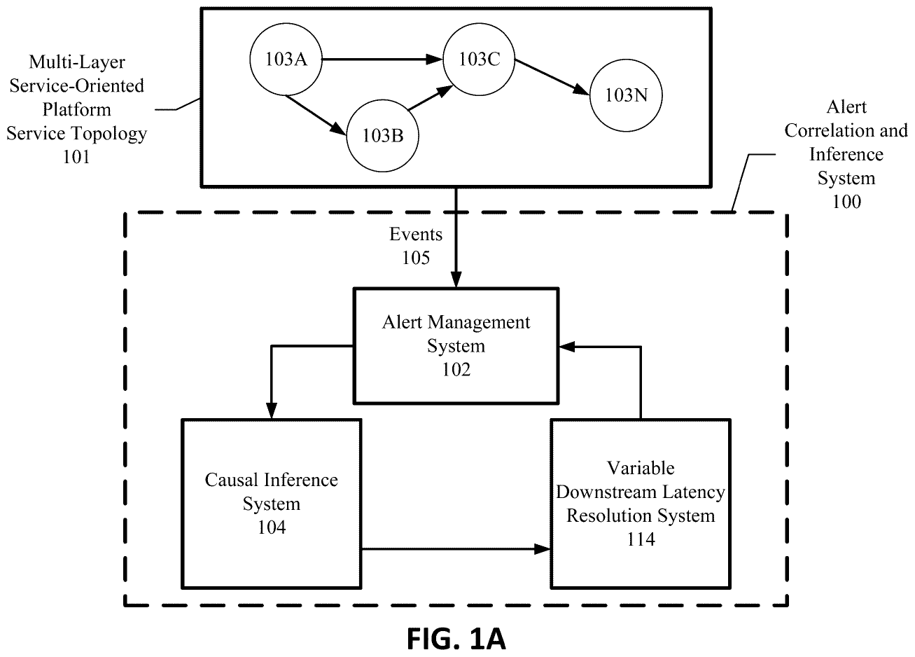

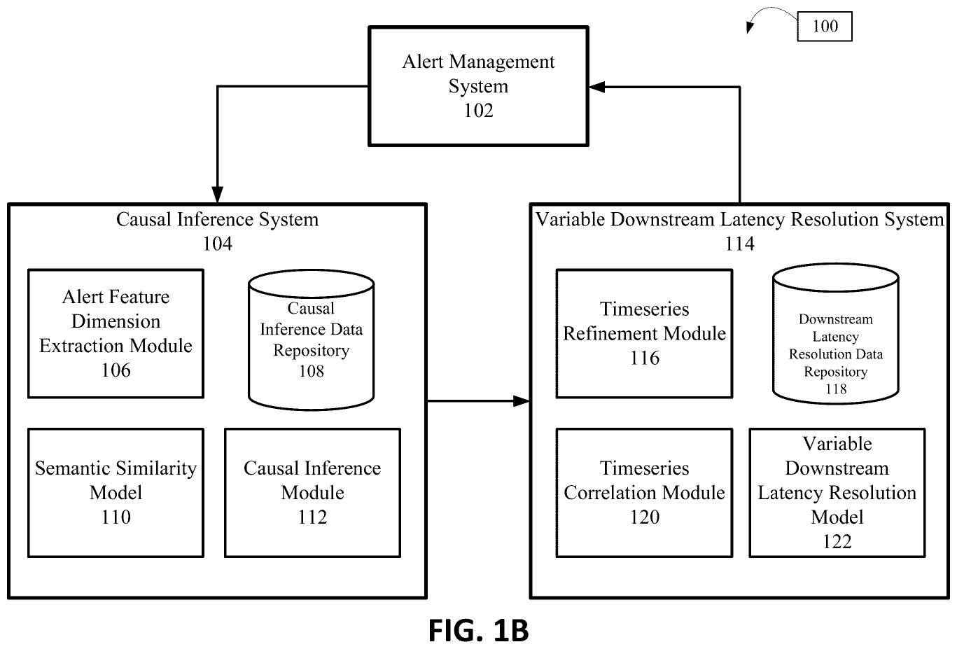

FIG. 1A illustrates a schematic view of an example data architecture for an alert correlation and inference system configured to monitor a multi-layer service-oriented platform. In the depicted embodiment, a multi-layer service-oriented platform having service topology 101 is configured to be monitored by alert management system 102. Exemplary service topology 101 is comprised of example services 103A-103N. In the depicted embodiment, service 103A is an upstream service of service 103B and service 103C. Service 103B is an upstream service of service 103C. Service 103C is an upstream service of service 103N.

In the depicted embodiment, an alert correlation and inference system 100 comprises alert management system 102, causal inference system 104, and variable downstream latency resolution system 114. FIG. 1A depicts causal inference system 104 and variable downstream latency resolution system 114 as discrete systems, but in various embodiments, causal inference system 104 and variable downstream latency resolution system 114 may be subsystems of alert management system 102.

In the depicted embodiment, alert management system 102 is configured to monitor the multi-layer service-oriented platform to detect and/or receive events 105. Upon detection or receipt of an event 105, alert management system 102 is configured to determine if event 105 necessitates generation of one or more alerts and is further configured to generate the one or more alerts.

FIG. 1B illustrates a schematic view of an example data architecture for a causal inference system and a variable downstream latency resolution system configured to interface with an alert management system within which embodiments of the present disclosure operate. In the depicted embodiment, an alert management system 102 is deployed in coordination with a causal inference system 104 and a variable downstream latency resolution system 114.

In the depicted embodiment, causal inference system 104 is comprised of alert feature dimension extraction module 106, causal inference data repository 108, semantic similarity model 110, and causal inference module 112. Variable downstream latency resolution system 114 is comprised of timeseries refinement module 116, downstream latency resolution data repository 118, timeseries correlation module 120, and variable downstream latency resolution model 122.

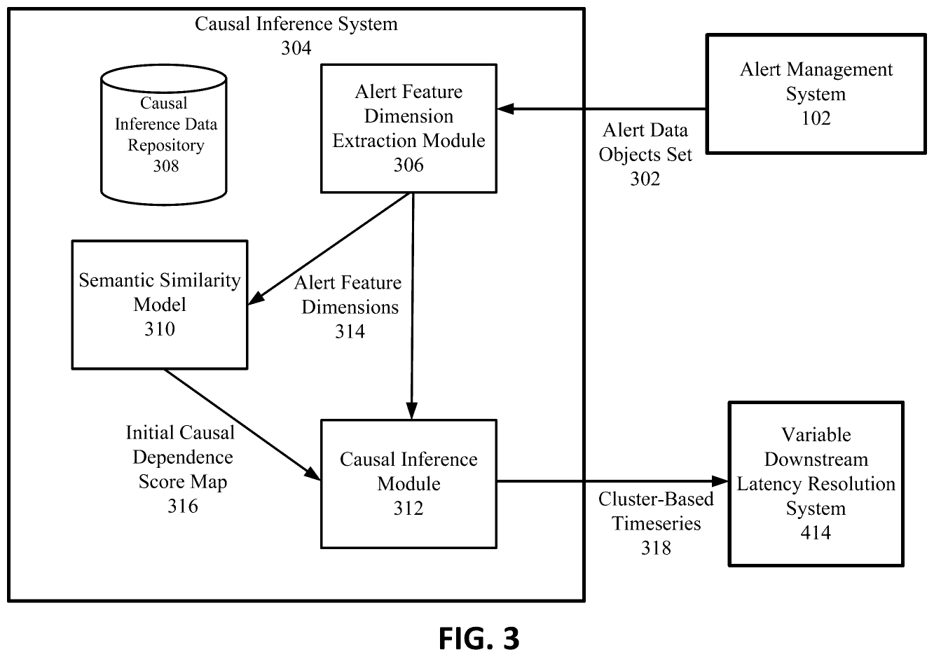

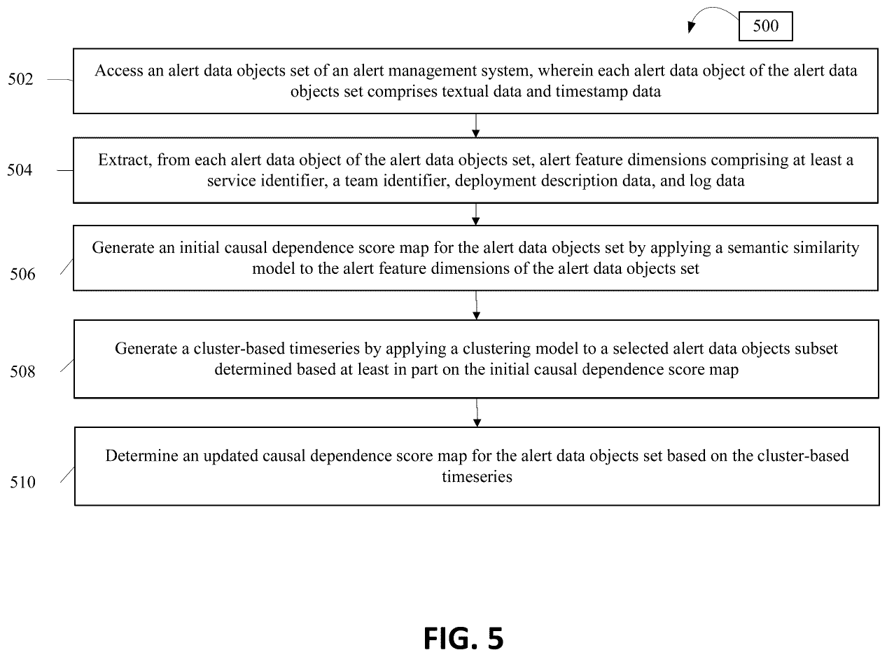

Causal inference system 104 is configured to receive a plurality of alert data objects from alert management system 102. Causal inference system 104 and its subcomponents are further configured to extract alert feature dimensions from the plurality of alert data objects, generate an initial causal dependence score map, generate cluster-based timeseries, determine an updated causal dependence score map, and provide the generated cluster-based timeseries to variable downstream latency resolution system 114. The functions of causal inference system 104 are described in more detail below with reference to FIGS. 3 and 5.

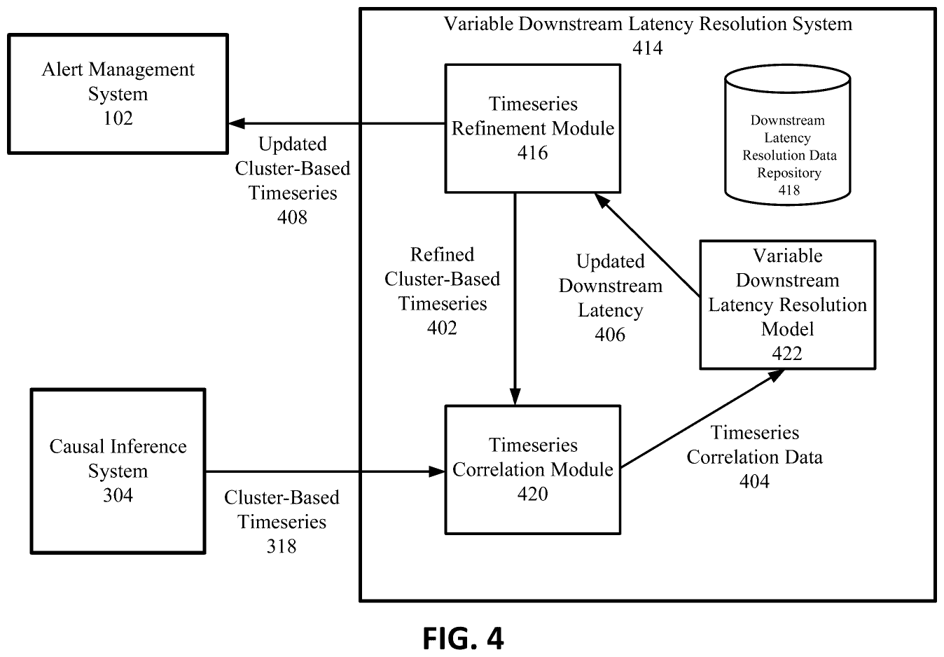

Variable downstream latency resolution system 114 and its subcomponents are further configured to receive a plurality of cluster-based timeseries from causal inference system 104, determine a downstream latency based on anomalous subgroups of the plurality of cluster-based timeseries, refine the cluster-based timeseries based on the downstream latency, determine an updated downstream latency by iteratively refining the cluster-based timeseries by adjusting the downstream latency until a timeseries correlation score reaches a predetermined timeseries correlation threshold, and provide the refined cluster-based timeseries to alert management system 102. The functions of variable downstream latency resolution system 114 are described in more detail below with reference to FIGS. 4, 6, and 7.

### Example Apparatuses

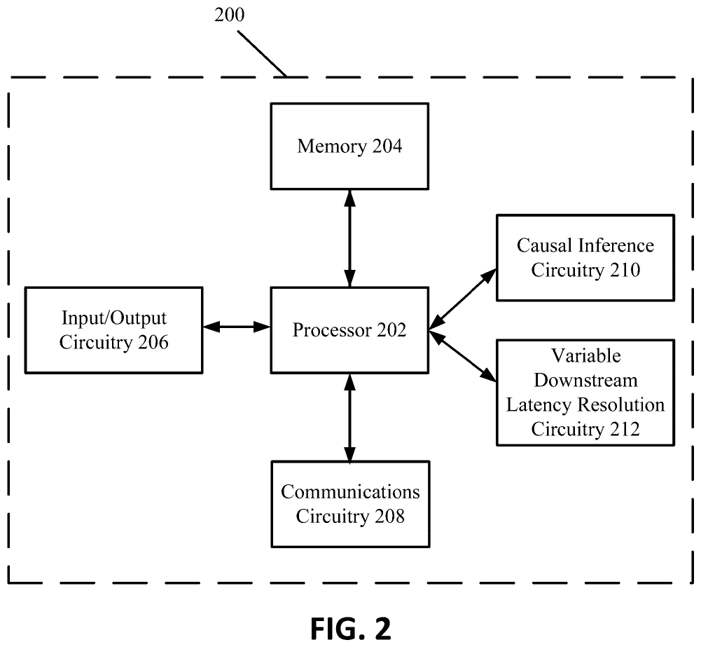

Referring now to FIG. 2, in the depicted embodiment, both causal inference system 104 and variable downstream latency resolution system 114 are embodied as apparatus 200 shown in schematic form. Apparatus 200 may be configured to execute operations enabled by one or more of the embodiments described in this disclosure. Apparatus 200 may be configured to embody causal inference system 104, variable downstream latency resolution system 114, or both.

According to various embodiments, the apparatus 200 may be a computer, a user device, or any suitable configuration of hardware and/or software capable of executing operations enabled by causal inference system 104 and variable downstream latency resolution system 114. In some embodiments, the apparatus 200 includes a processor 202, a memory 204, input/output circuitry 206, communications circuitry 208, causal inference circuitry 210, and/or variable downstream latency resolution circuitry 212.

The components of the apparatus 200 are described with respect to functional limitations. It should be understood that the particular implementations necessarily include the use of particular hardware. It should also be understood that certain of these components (processor 202, memory 204, input/output circuitry 206, communications circuitry 208, causal inference circuitry 210, and/or variable downstream latency resolution circuitry 212) may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) is in communication with the memory 204 via a bus for passing information among components of the apparatus. The memory 204 is non-transitory and includes, for example, one or more volatile and/or non-volatile memories. In other words, for example, the memory 204 is an electronic storage device (e.g., a computer-readable storage medium). The memory 204 is configured to store information, data, content, applications, instructions, or the like for enabling the apparatus to carry out various functions in accordance with example embodiments of the present invention.

The processor 202 is embodied in a number of different ways and may, for example, include one or more processing devices configured to perform independently. In some preferred and non-limiting embodiments, the processor 202 includes one or more processors configured in tandem via a bus to enable independent execution of instructions, pipelining, and/or multithreading. The use of the term “processing circuitry” is understood to include a single core processor, a multi-core processor, multiple processors internal to the apparatus, and/or remote or “cloud” processors.

In some preferred and non-limiting embodiments, the processor 202 is configured to execute instructions stored in the memory 204 or otherwise accessible to the processor 202. In some preferred and non-limiting embodiments, the processor 202 is configured to execute hard-coded functionalities. As such, whether configured by hardware or software methods, or by a combination thereof, the processor 202 represents an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed. In some embodiments, the memory 204 may be a non-transitory memory including program code that is configured to cause the apparatus 200 to provide various functionality associated with the alert feature dimension extraction module, the semantic similarity model, the causal inference module, the timeseries correlation module, the timeseries refinement module, and/or the variable downstream latency resolution model.

In some embodiments, the apparatus 200 includes input/output circuitry 206 that is, in turn, be in communication with processor 202 to provide output to the user and, in some embodiments, to receive an indication of a user input. The input/output circuitry further includes a web user interface, a mobile application, a query-initiating computing device, a kiosk, or the like.

In some embodiments, the input/output circuitry 206 also includes a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 is any means such as a device or circuitry embodied in either hardware or a combination of hardware and software that is configured to receive and/or transmit data from/to a network and/or any other device, circuitry, or module in communication with the apparatus 200. In this regard, the communications circuitry 208 includes, for example, a network interface for enabling communications with a wired or wireless communication network. For example, the communications circuitry 208 includes one or more network interface cards, antennae, buses, switches, routers, modems, and supporting hardware and/or software, or any other device suitable for enabling communications via a network. Additionally or alternatively, the communications circuitry 208 includes the circuitry for interacting with the antenna/antennae to cause transmission of signals via the antenna/antennae or to handle receipt of signals received via the antenna/antennae.

In some embodiments, apparatus 200 further comprises causal inference circuitry 210 which comprises a device or circuitry embodied in either hardware or a combination of hardware and software that is configured to provide cluster-based timeseries associated with one or more software application, enabling alert management systems to manage alerts efficiently in a manner that mitigates alert overload. For example, the causal inference circuitry 210 may include specialized circuitry that are configured to perform the functions of one or more of the alert feature extraction module, the semantic similarity model, and/or the causal inference module.

In some embodiments, apparatus 200 further comprises variable downstream latency resolution circuitry 212 which comprises a device or circuitry embodied in either hardware or a combination of hardware and software that is configured to provide refined cluster-based timeseries associated with one or more software application, enabling alert management systems to manage alerts efficiently in a manner that mitigates alert overload. For example, the variable downstream latency resolution circuitry 212 may include specialized circuitry that are configured to perform the functions of one or more of the alert timeseries refinement module, the variable downstream latency resolution model, and/or the timeseries correlation module.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Processes and Methods of Use

FIG. 3 depicts an example data flow for generation of a cluster-based timeseries by example causal inference system 304 configured in accordance with various embodiments of the present disclosure. Causal inference system 304 is configured to receive an alert data objects set 302 from alert management system 102 and output cluster-based timeseries 318 to variable downstream latency resolution system 414 as described in more detail with reference to FIG. 4 below.

In the depicted embodiment, causal inference system 304 receives an alert data objects set 302 from alert management system 102, wherein alert data objects set 302 comprises a plurality of alert data objects. For example, the alert data objects represent alerts generated in association with services 103A-103N. Alert feature dimension extraction module 306 is configured to extract alert feature dimensions 314 from each alert data object of alert data objects set 302. Alert feature dimension extraction module 306 may extract alert feature dimensions 314 by utilizing named entity recognition, other natural language processing techniques, or other feature extraction processes known in the art.

To ensure the accuracy and security of alert feature dimension extraction, alert feature dimension extraction module 306 may verify alert feature dimensions 314 against a set of known feature dimensions. The set of known feature dimensions is received from alert management system 102 and are stored in causal inference data repository 308. For example, to verify an alert data object having a service identifier associated with service 103A, alert feature dimension extraction module 306 queries the set of known feature dimensions stored in causal inference data repository 308 to ensure that the extracted service identifier of an alert data object is a known and valid service identifier. If the alert feature dimensions of an alert data object cannot be verified by the set of known feature dimensions, that alert data object may be removed from alert data objects set 302.

In the depicted embodiment, alert feature dimension extraction module 306 provides alert feature dimensions 314 for each alert data object to semantic similarity model 310 and causal inference module 312.

The depicted embodiment illustrates a semantic similarity model 310 as an example type of alert similarity module. Other forms of determining alert similarity such as co-occurrence-based similarity, frequency-based similarity, attribute-based similarity, syntactic similarity, and signal-based similarity may also be used.

Semantic similarity model 310 is configured to generate an initial causal dependence score map 316 based on the alert feature dimensions 314. The depicted semantic similarity model 310 is a machine learning model trained to output a semantic similarity score between two or more alert data objects. The semantic similarity score quantifies a degree to which two or more alert data objects are similar to each other. A semantic similarity score that satisfies a similarity score threshold indicates a strong similarity, whereas a semantic similarity score that does not satisfy a similarity score threshold indicates a weak similarity.

Semantic similarity model 310 generates initial causal dependence score map 316 by computing semantic similarity scores between some or all of the alert data objects of alert data objects set 302. Alert data objects with alert feature dimensions having matching service identifiers, matching team identifiers, or having semantically similar textual data, deployment description data, metric data, and log data are likely to produce semantic similarity scores which satisfy a similarity score threshold. For example, two alert data objects having textual data describing a network connection failure would be likely to receive a semantic similarity score which satisfies a similarity score threshold. Semantic similarity model 310 is configured to provide initial causal dependence score map 316 to causal inference module 312.

In some embodiments, an alert similarity module is configured to determine alert similarities and generate similarity scores via co-occurrence-based similarity methods. In these embodiments, the alert similarity module generates initial causal dependence score map 316 by computing similarity scores between some or all of the alert data objects of alert data objects set 302. Alert data objects occurring together (regardless of which alert occurred first) within a given timeframe and above a given occurrence threshold are likely to produce similarity scores which satisfy a similarity score threshold. For example, if two or more alerts occur within a co-occurrence time window (e.g., 3 seconds, 5 micro-seconds, etc.) for 80% of each alert's occurrences during a given timeframe, alert similarity module may determine that these alerts are highly similar. In some embodiments, initial causal dependence score map 316 may be generated in accordance with a plurality of forms of determining alert similarity, such semantic similarity and co-occurrence-based similarity.

In the depicted embodiment, causal inference module 312 is configured to receive alert feature dimensions 314 from alert feature dimension extraction module 306, receive initial causal dependence score map 316 from semantic similarity model 310, and generate one or more cluster-based timeseries 318.

Causal inference module 312 is configured to apply a clustering model, such as DBSCAN, K-means, or another clustering technique known in the art to generate clusters of alert data objects. The clustering model may be a trained machine learning model. The clustering model takes alert feature dimensions 314 and initial causal dependence score map 316 as input. Initial causal dependence score map 316 informs the clustering model of the similarities between each alert data object. Alert data objects may be clustered based solely on the similarities provided by initial causal dependence score map 316 or may be further refined by parameters sourced from alert feature dimensions 314, such as the service identifier. The depicted cluster-based timeseries 318 are generated by partitioning the alert clusters into subgroups based on a configurable time threshold and the timestamp of each alert data object.

In various embodiments, the service identifier is used to form the alert clusters based on the service of the software application that generated each respective alert. As an example, consider service 103A and service 103B, wherein service 103B is a dependent downstream service of service 103A. In this scenario, an event occurring in service 103A triggers generation of alert(s) A1. Due to the hierarchical dependency between service 103A and service 103B, service 103B may begin to experience event occurrences, thus triggering generation of alert(s) A2. In traditional alert management systems, alerts A1 and A2 are treated as separate alerts that must be triaged in order to identify root causes thereof and or to determine a possible association with one or more incidents. Because the original source of the event occurred in service 103A and not service 103B, traditional alert management systems waste valuable time and resources investigating A2, which is a false positive. When clustering based on the service identifier, causal inference module 312 is configured to cluster alerts originating from service 103A (including A1) into cluster C1 and alerts originating from service 103B (including A2) into cluster C2.

In various embodiments, a cluster-based timeseries TS1 is generated by partitioning the alerts of C1 into subgroups based on a configurable time threshold. Similarly, a cluster-based timeseries TS2 is generated by partitioning the alerts of C2 into subgroups based on the same configurable time threshold as TS1. Due to the hierarchical dependency between service 103A and service 103B, the timestamp of A2 will be offset from the timestamp of A1. This offset is also referred to as a downstream latency.

By analyzing patterns in alert occurrences in each subgroup and variances in downstream latencies between correlated subgroups of different cluster-based timeseries, causal inference module 312 is configured to infer causation between two or more cluster-based timeseries. Continuing the example from above, causal inference module 312 may determine that TS2 is causally dependent on TS1. Therefore, future alert data objects clustered into TS2 are dependent on prior alert data objects on TS1.

By detecting this causal relationship between cluster-based timeseries, causal inference system 304 enables alert management system 102 to perform fault localization, blast radius estimation, root cause analysis, and incident prediction. Continuing the above example, by detecting that alerts of TS2 are causally dependent on alerts of TS1, alert management system 102 is able to determine that A2 was caused by A1, and the source of the failure is located in service 103A. Alert management system 102 is also enabled to perform blast radius estimation, thus determining that service 103B is affected by the events in service 103A. Alert management system 102 is further enabled to perform incident prediction. After establishing a causal relationship between TS1 and TS2, when a new alert is assigned to TS1 by causal inference module 312, it can be predicted that a correlated alert may occur in service 103B roughly within a time interval associated with the downstream latency between TS1 and TS2 and the timestamp of the new alert.

In various embodiments, causal inference module 312 infers causality by utilizing statistical methods such as granger causality or hidden Markov models. When utilizing a granger causality method, causality can be inferred by determining that past values of TS1 are necessary for computing values of TS2. When utilizing hidden Markov models, causality can be inferred by observing historical occurrences of alerts in a given time interval. For example, if 90% (or any threshold deemed appropriate) of A2's occurrences are observed after an occurrence of A1, it can be inferred that A1 caused A2.

After the establishment of a causal relationship between two or more cluster-based timeseries, causal inference module 312 may be configured to generate an updated causal dependence score map based on the initial causal dependence score map. Alert data objects deemed to have a causal relationship may have their similarity scores updated. The updated causal dependence score map is stored in causal inference data repository 308 and is used as training data for future iterations of the semantic similarity model 310 or the clustering model to improve the accuracy of clustering alert data objects and assigning them to existing cluster-based timeseries.

FIG. 4 depicts an example data flow for the generation of updated cluster-based timeseries by variable downstream latency resolution system 414 configured in accordance with various embodiments of the present disclosure.

In the depicted embodiment, variable downstream latency resolution system 414 is configured to receive two or more cluster-based timeseries 318 from causal inference system 304. Each cluster-based timeseries 318 is comprised of a plurality of alert data objects. As an example, consider a scenario where service 103A is a database service experiencing network connectivity problems and service 103B is a frontend service. Since service 103B is a downstream service of service 103A, service 103B begins experiencing database fetching errors. The alerts triggered by the network connectivity problems in service 103A have been clustered into a first cluster-based timeseries and the alerts triggered by the database fetching errors in service 103B have been clustered into a second cluster-based timeseries by causal inference module 312.

Timeseries correlation module 420 is configured to analyze the first cluster-based timeseries and the second cluster-based timeseries to identify a set of anomalous subgroups of the first cluster-based timeseries and a set of anomalous subgroups of the second cluster-based timeseries. In this example, an anomalous subgroup of the first cluster-based timeseries contains a high frequency of network connectivity alerts that were not present in previous subgroups that occurred when service 103A was functioning properly. Similarly, an anomalous subgroup of the second cluster-based timeseries contains a high frequency of database fetching error alerts that were not present in previous subgroups that occurred when service 103B was functioning properly. In another example, an anomalous subgroup of the first cluster-based timeseries may contain an occurrence of a rare and/or severe alert, and an anomalous subgroup of the second cluster-based timeseries may contain a similar occurrence of the rare and/or severe alert.

Timeseries correlation module 420 is further configured to correlate anomalous subgroups of the first cluster-based timeseries to anomalous subgroups of the second cluster-based timeseries. Timeseries correlation module 420 is further configured to determine a timeseries correlation score configured to quantify a degree to which the set of anomalous subgroups of the first cluster-based timeseries are correlated to the set of anomalous subgroups of the second cluster-based timeseries. A timeseries correlation score which satisfies a predefined timeseries correlation threshold indicates that the downstream latency associated with partitioning the cluster-based timeseries into subgroups has resulted in highly correlated subgroups, thus improving an alert management system's ability to perform fault localization, blast radius estimation, root cause analysis, and incident prediction.

In various embodiments, timeseries correlation module 420 may additionally model, based on a probability distribution, time deltas between start times of each anomalous subgroup of the set of anomalous subgroups. Modelling the distributions of time deltas between anomalous subgroup start times enables a variable downstream latency resolution model to update the downstream latency with a value configured to properly capture the anomalies of the first cluster-based timeseries and the second cluster-based timeseries. If the updated downstream latency is too narrow, resultant subgroups may not encapsulate enough alert data objects to allow proper detection of anomalies. If the updated downstream latency is too wide, resultant subgroups may encapsulate too many alert data objects, which may cause multiple unrelated anomalies to be included within the same subgroup.

Timeseries correlation module 420 is configured to provide timeseries correlation data 404 to variable downstream latency resolution model 422. Timeseries correlation data 404 comprises data identifying the anomalous subgroups of each cluster-based timeseries and timeseries correlation scores between the correlated anomalous subgroups of each cluster-based timeseries. Timeseries correlation data 404 may additionally comprise the modeled probability distribution of time deltas between start times of each anomalous subgroup of the set of anomalous subgroups.

Variable downstream latency resolution model 422 is configured to generate an updated downstream latency 406 based on the anomalous subgroups and timeseries correlation scores identified by timeseries correlation data 404. The updated downstream latency 406 is determined based on a time delay between a start time of an anomalous subgroup of the first cluster-based timeseries and a start time of a correlated anomalous subgroup of the second cluster-based timeseries. Variable downstream latency resolution model 422 is further configured to provide the updated downstream latency 406 to timeseries refinement module 416.

In this example, the updated downstream latency 406 is measured from the time of the initial spike of network connectivity alerts in the first cluster-based timeseries to the time of the initial spike of database fetching error alerts in the second cluster-based timeseries.

Timeseries refinement module 416 is configured to generate a first refined cluster-based timeseries and a second refined cluster-based timeseries based on the updated downstream latency 406. Each refined cluster-based timeseries 402 is generated by repartitioning their respective cluster-based timeseries into subgroups, wherein the configurable time threshold is the updated downstream latency 406.

Continuing the above example, if the initial spike of network connectivity alerts in the first cluster-based timeseries occurred at time t and the initial spike of database fetching error alerts in the second cluster-based timeseries occurred at time t+10 milliseconds, the updated downstream latency 406 may be determined to be 10 milliseconds. Therefore, upon repartitioning the first and second cluster-based timeseries into new subgroups based on a configurable time threshold of 10 milliseconds, the initial spike of network connectivity alerts in the first cluster-based timeseries may be wholly encapsulated by a single subgroup, as opposed to the initial spike of network connectivity alerts in the first cluster-based timeseries being erroneously split into adjacent subgroups. Likewise, the initial spike of database fetching error alerts in the second cluster-based timeseries may be wholly encapsulated by a single subgroup, as opposed to the initial spike of database fetching error alerts in the second cluster-based timeseries being erroneously split into adjacent subgroups.

In this simple example with only one pair of correlated anomalous subgroups, variable downstream latency resolution system 414 is easily able to wholly encapsulate the correlated anomalies into a single subgroup. However, in a real-world scenario with hundreds of anomalous subgroups within a cluster-based timeseries, each having differing downstream latencies with correlated anomalous subgroups of another cluster-based timeseries, many rounds of timeseries refinement may be required to reach an updated downstream latency value which results in refined cluster-based timeseries having a timeseries correlation score which satisfies a predefined timeseries correlation threshold.

Timeseries refinement module 416 is configured to provide the first and second refined cluster-based timeseries 402 to timeseries correlation module 420. Upon receipt of a first and second refined cluster-based timeseries 402, timeseries correlation module reinitiates the timeseries refinement process described above.

The timeseries refinement process repeats until a timeseries correlation score identified in timeseries correlation data 404 reaches a predefined timeseries correlation threshold. Upon reaching the predefined timeseries correlation threshold, timeseries refinement module 416 refines the first and second refined cluster-based timeseries to generate a first and second updated cluster-based timeseries 408. Timeseries refinement module 416 is configured to provide the first and second updated cluster-based timeseries 408 to alert management system 102. By iteratively updating the downstream latency used for iteratively refining the first and second cluster-based timeseries to optimize a timeseries correlation score, alert management system 102 is provided with high quality timeseries data configured specifically to enable alert management system 102 to efficiently perform highly accurate fault localization, blast radius estimation, root cause analysis, and incident prediction of alerts.

Continuing the example above, because a scenario with only two services and only one root cause error is quite simple, it may be determined based on the timeseries correlation score that further refinement of the cluster-based timeseries is not necessary. In a real-world example with complex service topologies of thousands of inter-dependent services and multiple root cause errors, attempting to perform root cause analysis and incident prediction without refined cluster-based timeseries becomes computationally extreme.

FIG. 5 shows an example flow chart illustrating example method 500 of generating a cluster-based timeseries and determining an updated causal dependence score map in accordance with various embodiments of the present disclosure. In some embodiments, the depicted method 500 may be a computer-implemented method for execution by an apparatus 200 (shown in FIG. 2) of a causal inference system 104 (shown in FIG. 1B) or an example causal inference system 304 (shown in FIG. 3). It will be understood that the depicted method 500 may be implemented using any suitable system, apparatus, and their various components.

At block 502 of the depicted method 500, a causal inference system receives, from an alert management system, an alert data objects set, wherein each alert data object of the alert data objects set comprises textual data and timestamp data.

In various embodiments, the textual data describes an event associated with a software application. For example, an alert data object generated based on a network connectivity failure in a backend service comprises textual data describing an error type (network connectivity failure), a network identifier of the network that the backend service was attempting to connect to, and additional information regarding associated hardware/devices, IP addresses, or domain names.

At block 504, an alert feature extraction module extracts, from each alert data object of the alert data objects set, alert feature dimensions comprising at least a service identifier, a team identifier, deployment description data, and log data.

In various embodiments, an alert feature extraction module may receive, from the alert management system, a set of known feature dimensions and verify, for each alert data object and based on a set of known feature dimensions, the alert feature dimensions. The alert feature extraction module may be further configured to utilize a named entity recognition process.

At block 506, a causal inference system generates an initial causal dependence score map for the alert data objects set by applying a semantic similarity model to the alert feature dimensions of the alert data objects set.

At block 508, a causal inference module generates a cluster-based timeseries by applying a clustering model to a selected alert data objects subset determined based at least in part on the initial causal dependence score map.

In various embodiments, the generation of cluster-based timeseries further comprises determining, based on applying the semantic similarity model, alert clusters and generating, based on the alert clusters and the timestamp data, the cluster-based timeseries by partitioning the alert clusters into subgroups based on a configurable time threshold.

In various embodiments, the cluster-based timeseries is generated based at least in part on the service identifier.

At block 510, a causal inference module determines an updated causal dependence score map for the alert data objects set based on the cluster-based timeseries.

In various embodiments, the updated causal dependence score map is determined by augmenting a Granger Causality method.

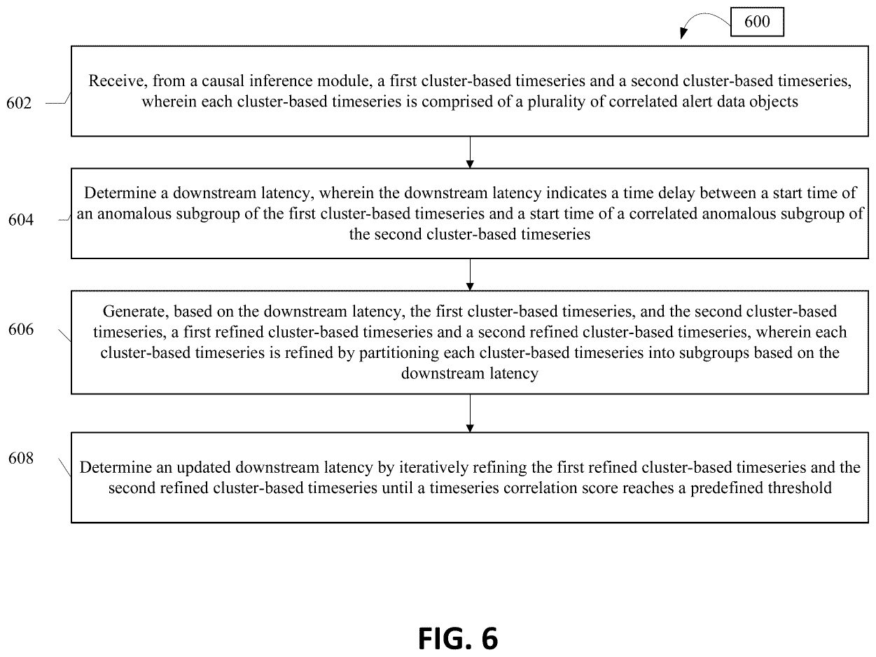

FIG. 6 shows an example flow chart illustrating an example method 600 of iteratively refining a first and second cluster-based timeseries in accordance with various embodiments of the invention. In some embodiments, the depicted method 600 may be a computer-implemented method for execution by an apparatus 200 (shown in FIG. 2) of a variable downstream latency resolution system 114 (shown in FIG. 1B) or an example variable downstream latency resolution system 414 (shown in FIG. 4). It will be understood that the depicted method 600 may be implemented using any suitable system, apparatus, and their various components.

At block 602 of the depicted method 600, a variable downstream latency resolution system receives, from a causal inference module, a first cluster-based timeseries and a second cluster-based timeseries, wherein each cluster-based timeseries is comprised of a plurality of correlated alert data objects.

In various embodiments, a timeseries correlation module may identify, based on the subgroups, a set of anomalous subgroups of the first refined cluster-based timeseries and the second refined cluster-based timeseries and determine the timeseries correlation score between the set of anomalous subgroups of the first refined cluster-based timeseries and the set of anomalous subgroups of the second refined cluster-based timeseries.

At block 604, a variable downstream latency resolution model determines a downstream latency, wherein the downstream latency indicates a time delay between a start time of an anomalous subgroup of the first cluster-based timeseries and a start time of a correlated anomalous subgroup of the second cluster-based timeseries.

In various embodiments, the downstream latency is determined based at least in part on the timeseries correlation score.

At block 606, a timeseries refinement module generates, based on the downstream latency, the first cluster-based timeseries, and the second cluster-based timeseries, a first refined cluster-based timeseries and a second refined cluster-based timeseries, wherein each cluster-based timeseries is refined by partitioning each cluster-based timeseries into subgroups based on the downstream latency.

At block 608, a variable downstream latency resolution system determines an updated downstream latency by iteratively refining the first refined cluster-based timeseries and the second refined cluster-based timeseries until a timeseries correlation score reaches a predefined timeseries correlation threshold.

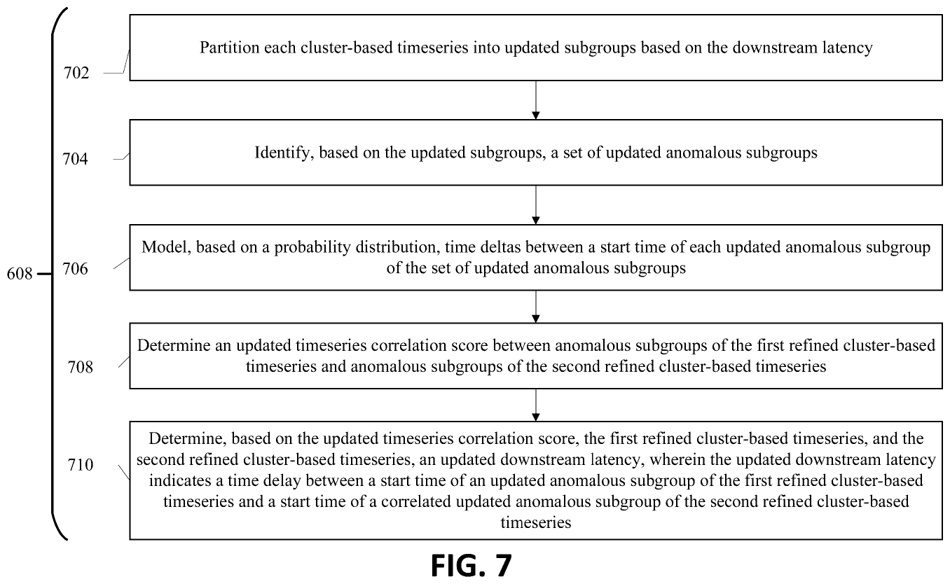

The operations of block 608 for determining an updated downstream latency by refining the first refined cluster-based timeseries and the second refined cluster-based timeseries are further illustrated by FIG. 7.

At block 702, a variable downstream latency resolution system partitions each cluster-based timeseries into updated subgroups based on the downstream latency.

At block 704, a variable downstream latency resolution system identifies, based on the updated subgroups, a set of updated anomalous subgroups.

At block 706, a variable downstream latency resolution system models, based on a probability distribution, time deltas between a start time of each updated anomalous subgroup of the set of updated anomalous subgroups.

At block 708, a variable downstream latency resolution system determines an updated timeseries correlation score between anomalous subgroups of the first refined cluster-based timeseries and anomalous subgroups of the second refined cluster-based timeseries.

At block 710, a variable downstream latency resolution system determines, based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

In various embodiments, upon a timeseries correlation score reaching a predefined timeseries correlation threshold, a variable downstream latency resolution system is further configured to generate, based on the updated downstream latency, the first refined cluster-based timeseries, and the second refined cluster-based timeseries, a first updated cluster-based timeseries and a second updated cluster-based timeseries and transmit, to an alert management system, the first updated cluster-based timeseries and a second updated cluster-based timeseries.

In various embodiments, generating the first updated cluster-based timeseries and the second updated cluster-based timeseries further comprises partitioning each cluster-based timeseries into subgroups based on the updated downstream latency.

In various embodiments, the first updated cluster-based timeseries and the second updated cluster-based timeseries are configured to enable the alert management system to efficiently handle alerts.

In various embodiments, a multi-tiered timeseries refinement process comprises performing the following actions on a first and a second cluster-based timeseries: (i) partitioning, by a timeseries refinement module, each cluster-based timeseries into updated subgroups based on the downstream latency, (ii) identifying, by a timeseries correlation module and based on the updated subgroups, a set of updated anomalous subgroups, (iii) modelling, by the timeseries correlation module and based on a probability distribution, time deltas between a start time of each updated anomalous subgroup of the set of updated anomalous subgroups, (iv) determining, by the timeseries correlation module, an updated timeseries correlation score between anomalous subgroups of the first refined cluster-based timeseries and anomalous subgroups of the second refined cluster-based timeseries, and (v) determining, by a variable downstream latency resolution model and based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising one or more processors and one or more memories storing instructions that are operable, when executed by the one or more processors, to cause the apparatus to:
receive, from a causal inference module, a first cluster-based timeseries and a second cluster-based timeseries, wherein each cluster-based timeseries is comprised of a plurality of similar and/or correlated alert data objects;
determine an anomalous subgroup of the first cluster-based timeseries and determine a correlated anomalous subgroup of the second cluster-based timeseries;
determine a downstream latency, wherein the downstream latency indicates a time delay between a start time of the anomalous subgroup of the first cluster-based timeseries and a start time of the correlated anomalous subgroup of the second cluster-based timeseries;
generate a first refined cluster-based timeseries and a second refined cluster-based timeseries by partitioning each cluster-based timeseries into subgroups based on the downstream latency;
determine an additional anomalous subgroup of the first refined cluster-based timeseries and determine a correlated additional anomalous subgroup of the second refined cluster-based timeseries;
determine an updated downstream latency, wherein the updated downstream latency indicates a time delay between a start time of the additional anomalous subgroup of the first refined cluster-based timeseries and a start time of the correlated additional anomalous subgroup of the second refined cluster-based timeseries; and
output, to an alert management system, the first refined cluster-based timeseries and the second refined cluster-based timeseries.

2. The apparatus of claim 1, wherein the instructions, when executed by the one or more processors, further cause the apparatus to:
iteratively refine the first refined cluster-based timeseries and the second refined cluster-based timeseries by:
(i) partitioning each cluster-based timeseries into updated subgroups based on the downstream latency;
(ii) identifying, based on the updated subgroups, a set of updated anomalous subgroups;
(iii) modelling, based on a probability distribution, time deltas between a start time of each updated anomalous subgroup of the set of updated anomalous subgroups;
(iv) determining an updated timeseries correlation score between anomalous subgroups of the first refined cluster-based timeseries and anomalous subgroups of the second refined cluster-based timeseries; and
(v) determining, based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

3. The apparatus of claim 1, wherein the instructions, when executed by the one or more processors, further cause the apparatus to:
identify, based on the subgroups, a set of anomalous subgroups of the first refined cluster-based timeseries and the second refined cluster-based timeseries; and
determine a timeseries correlation score between the set of anomalous subgroups of the first refined cluster-based timeseries and the set of anomalous subgroups of the second refined cluster-based timeseries.

4. The apparatus of claim 3, wherein the downstream latency is determined based at least in part on the timeseries correlation score.

5. The apparatus of claim 1, wherein the instructions, when executed by the one or more processors, further cause the apparatus to:
generate, based on the updated downstream latency, the first refined cluster-based timeseries, and the second refined cluster-based timeseries, a first updated cluster-based timeseries and a second updated cluster-based timeseries; and
output, to an alert management system, the first updated cluster-based timeseries and the second updated cluster-based timeseries.

6. The apparatus of claim 5, wherein generating the first updated cluster-based timeseries and the second updated cluster-based timeseries further comprises:
partitioning each cluster-based timeseries into subgroups based on the updated downstream latency.

7. The apparatus of claim 5, wherein the first updated cluster-based timeseries and the second updated cluster-based timeseries are configured to enable the alert management system to efficiently handle alerts.

8. A computer-implemented method comprising:
receiving, from a causal inference module, a first cluster-based timeseries and a second cluster-based timeseries, wherein each cluster-based timeseries is comprised of a plurality of similar and/or correlated alert data objects;
determining an anomalous subgroup of the first cluster-based timeseries and determine a correlated anomalous subgroup of the second cluster-based timeseries;
determining a downstream latency, wherein the downstream latency indicates a time delay between a start time of the anomalous subgroup of the first cluster-based timeseries and a start time of the correlated anomalous subgroup of the second cluster-based timeseries;
generating a first refined cluster-based timeseries and a second refined cluster-based timeseries by partitioning each cluster-based timeseries into subgroups based on the downstream latency;
determining an additional anomalous subgroup of the first refined cluster-based timeseries and determine a correlated additional anomalous subgroup of the second refined cluster-based timeseries;
determining an updated downstream latency, wherein the updated downstream latency indicates a time delay between a start time of the additional anomalous subgroup of the first refined cluster-based timeseries and a start time of the correlated additional anomalous subgroup of the second refined cluster-based timeseries; and
outputting, to an alert management system, the first refined cluster-based timeseries and the second refined cluster-based timeseries.

9. The computer-implemented method of claim 8, further comprising a multi-tiered timeseries refinement process comprising:
iteratively refining the first refined cluster-based timeseries and the second refined cluster-based timeseries by:
(i) partitioning, by a timeseries refinement module, each cluster-based timeseries into updated subgroups based on the downstream latency;
(ii) identifying, by a timeseries correlation module and based on the updated subgroups, a set of updated anomalous subgroups;
(iii) modelling, by the timeseries correlation module and based on a probability distribution, time deltas between a start time of each updated anomalous subgroup of the set of updated anomalous subgroups;
(iv) determining, by the timeseries correlation module, an updated timeseries correlation score between anomalous subgroups of the first refined cluster-based timeseries and anomalous subgroups of the second refined cluster-based timeseries; and
(v) determining, by a variable downstream latency resolution model and based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

10. The computer-implemented method of claim 8, further comprising:
identifying, based on the subgroups, a set of anomalous subgroups of the first refined cluster-based timeseries and the second refined cluster-based timeseries; and
determining a timeseries correlation score between the set of anomalous subgroups of the first refined cluster-based timeseries and the set of anomalous subgroups of the second refined cluster-based timeseries.

11. The computer-implemented method of claim 10, wherein the downstream latency is determined based at least in part on the timeseries correlation score.

12. The computer-implemented method of claim 8, further comprising:
generating, based on the updated downstream latency, the first refined cluster-based timeseries, and the second refined cluster-based timeseries, a first updated cluster-based timeseries and a second updated cluster-based timeseries; and
outputting, to an alert management system, the first updated cluster-based timeseries and the second updated cluster-based timeseries.

13. The computer-implemented method of claim 12, wherein generating the first updated cluster-based timeseries and the second updated cluster-based timeseries further comprises:
partitioning each cluster-based timeseries into subgroups based on the updated downstream latency.

14. The computer-implemented method of claim 12, wherein the first updated cluster-based timeseries and the second updated cluster-based timeseries are configured to enable the alert management system to efficiently handle alerts.

15. A computer program product comprising at least one non-transitory computer-readable storage medium having computer-readable program code portions stored therein, the computer-readable program code portions comprising an executable portion configured to:
receive, from a causal inference module, a first cluster-based timeseries and a second cluster-based timeseries, wherein each cluster-based timeseries is comprised of a plurality of similar and/or correlated alert data objects;
determine an anomalous subgroup of the first cluster-based timeseries and determine a correlated anomalous subgroup of the second cluster-based timeseries;
determine a downstream latency, wherein the downstream latency indicates a time delay between a start time of the anomalous subgroup of the first cluster-based timeseries and a start time of the correlated anomalous subgroup of the second cluster-based timeseries;
generate a first refined cluster-based timeseries and a second refined cluster-based timeseries by partitioning each cluster-based timeseries into subgroups based on the downstream latency;
determine an additional anomalous subgroup of the first refined cluster-based timeseries and determine a correlated additional anomalous subgroup of the second refined cluster-based timeseries;
determine an updated downstream latency, wherein the updated downstream latency indicates a time delay between a start time of the additional anomalous subgroup of the first refined cluster-based timeseries and a start time of the correlated additional anomalous subgroup of the second refined cluster-based timeseries; and
output, to an alert management system, the first refined cluster-based timeseries and the second refined cluster-based timeseries.

16. The computer program product of claim 15, wherein the computer-readable program code portions comprising an executable portion are further configured to:
iteratively refine the first refined cluster-based timeseries and the second refined cluster-based timeseries by:
(i) partitioning each cluster-based timeseries into updated subgroups based on the downstream latency;
(ii) identifying, based on the updated subgroups, a set of updated anomalous subgroups;
(iii) modelling, based on a probability distribution, time deltas between a start time of each updated anomalous subgroup of the set of updated anomalous subgroups;
(iv) determining an updated timeseries correlation score between anomalous subgroups of the first refined cluster-based timeseries and anomalous subgroups of the second refined cluster-based timeseries; and
(v) determining, based on the updated timeseries correlation score, the first refined cluster-based timeseries, and the second refined cluster-based timeseries, an updated downstream latency, wherein the updated downstream latency indicates a time delay between a start time of an updated anomalous subgroup of the first refined cluster-based timeseries and a start time of a correlated updated anomalous subgroup of the second refined cluster-based timeseries.

17. The computer program product of claim 15, wherein the computer-readable program code portions comprising an executable portion are further configured to:
identify, based on the subgroups, a set of anomalous subgroups of the first refined cluster-based timeseries and the second refined cluster-based timeseries; and
determine a timeseries correlation score between the set of anomalous subgroups of the first refined cluster-based timeseries and the set of anomalous subgroups of the second refined cluster-based timeseries.

18. The computer program product of claim 17, wherein the downstream latency is determined based at least in part on the timeseries correlation score.

19. The computer program product of claim 15, wherein the computer-readable program code portions comprising an executable portion are further configured to:
generate, based on the updated downstream latency, the first refined cluster-based timeseries, and the second refined cluster-based timeseries, a first updated cluster-based timeseries and a second updated cluster-based timeseries; and
output, to an alert management system, the first updated cluster-based timeseries and the second updated cluster-based timeseries.

20. The computer program product of claim 19, wherein generating the first updated cluster-based timeseries and the second updated cluster-based timeseries further comprises:
partitioning each cluster-based timeseries into subgroups based on the updated downstream latency.
